(19) United States
(12) Patent Application Publication
(10) Pub. No.: US 2004/0137212 A1
(43) Pub. Date: Jul. 15, 2004

(54) Composite mat

(75) Inventors: Randy Ochoa, Richardson, TX (US); Larry West, Trophy Club, TX (US); Natarajan S. Ramesh, Grapevine, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sealed Air Corporation (US)

(21) Appl. No.: 10/341,989

(22) Filed: Jan. 14, 2003

(51) Int. Cl. B32B 3/26

(52) U.S. Cl. 428/319.3; 428/317.9; 428/72; 428/158

(57) ABSTRACT

The invention is a composite mat that is useful in horse trailers, assembly-line settings, specialty packaging, or the like. The mat has a force distributing upper layer and an impact absorbing layer disposed below the force distributing layer.

### BACKGROUND OF THE INVENTION

This invention relates generally to fatigue mats, and in particular, to fatigue mats that are useful in horse trailers.

A problem associated with transporting horses over an extended duration is fatigue and stress that can occur in the legs and joints. Riding in a trailer is not a natural activity for a horse. Although horses are very good at keeping their balance when they are moving under their own power, the motions of a trailer are difficult for them. During transportation a horse must balance itself by shifting its weight and moving its body. Because a horse's center of gravity is very high, it is difficult for the horse to counteract the momentum of the trailer as it accelerates, breaks, turns, and bounces.

A horse will move its legs and feet in the trailer to better brace itself against the changing forces acting on its body. Since the horse cannot anticipate the driver's actions (stopping, changing lanes, accelerating, etc.), it must always be reacting. In many cases, it must react very quickly to keep its balance. These reactions often lead to the horse forcibly thrusting its legs downward against the trailer's floor. During transit, a horse may become stressed or frightened and actually kick the floor or jump against the floor. As a result, the horse may deliver a substantial amount of downward force directly against the floor.

Horses are often transported in trailers standing on a steel or aluminum floor, or on a thin rubber or foam mat covering the floor. The bare floor, foam, or rubber mat provides insufficient absorption of impact energy, and the horse may feel a substantial amount of the impact force in their legs and joints. If the floor or mat is insufficient to absorb the impact force, not only does the horse feel the impact of hitting a hard surface, but the impact force is retransmitted back into the horse's legs and joints. This may result in the horse suffering stress, muscular fatigue, and occasionally a fractured bone. After the trip is completed, the horse may require a substantial length of time to fully recover.

A need exists for a fatigue mat that will absorb a large percentage of an impact force exerted on it.

### BRIEF SUMMARY OF THE INVENTION

The invention is a composite mat that is capable of absorbing a substantial amount of impact force directed against it without retransmitting the impact force back into the source. Mats in accordance with the invention have superior impact absorption capabilities making them ideally suited for use as fatigue mats and in other applications where it is desirable to reduce the amount of impact and rebound force.

It has been discovered that a foam having a density range from about 1 to 2.2 pounds per cubic foot (“pcf”), when used in a composite structure in accordance with the invention, provides improved impact absorption compared to foams of densities outside this range. Composite mats in accordance with the invention have a layer of polyolefin low-density foam disposed beneath a layer of dense polymer material, typically a synthetic rubber. The synthetic rubber is at least about 1/8 inch thick, and mats are from about ¼ to 1.5 inches thick are useful. Thicker mats may be used, although not necessarily with equivalent results.

Orientation of the foam layer beneath the dense polymer layer is an important feature. While not wishing to be bound by theory, it is believed that the dense polymer layer acts as force distributing layer and distributes an impact force that is exerted against it throughout its surface before transferring the force into the foam layer, which acts as an impact absorbing layer.

The impact absorbing layer is typically a polyethylene foam. It is desirable that the impact absorbing foam has a density that is from about 1.2 to 1.7 pcf. Foams having densities that are from about 1 to 2 pcf or 1 to 2.2 pcf have acceptable impact absorption. Densities greater than about 2.2 pcf normally do not have the minimum desirable impact absorption.

The foam's thickness does not affect impact absorbance as much as density. Foams in accordance with the invention normally have a thickness range that is from about ½ to 2.5 inches, with foam that is close to about 1 inch thick being the usual case. Although any thickness can be useful, up to 4 inches or more, there are practical limitations on weight and polymer expense that will preclude thicker foams.

Alternatively, the foam layer can be substituted or combined with a separate layer of air cellular material. To provide the necessary impact absorption, bubbles in air cellular material should be at least about 1/4 inch in diameter or larger. In yet another embodiment, a non-foamed mat can be placed under the impact absorbing layer, if desired, whenever it is necessary to protect the impact absorbency of the foam component.

An antimicrobial or antifungal agent can be added to the fatigue mat to prevent the growth and reproduction of microorganisms. The agents can be topically applied to the layers or incorporated into the individual polymeric structures of the layers.

Thus, composite mats in accordance with the invention have superior impact absorbance capabilities. The mats are useful as fatigue mats in horse trailers, stalls, and the like, and for specialty packaging, walkways, assembly-line workstations, and the like. A typical horse trailer fatigue mat is a composite mat of a 1 inch sheet of synthetic, vulcanized rubber laid over a layer of continuously extruded polyethylene foam that is about 1 inch thick and has a density that is of about 1.7 pcf.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective of a composite mat that is in accordance with the invention;

FIG. 2 is a side cross-sectional view of the composite mat depicted in FIG. 1;

FIG. 3 is a side cross-sectional view of the composite mat depicted in FIG. 1 illustrating an impact force being transmitted throughout the mat;

FIG. 4 is a side cross-sectional view of a composite mat that is in accordance with the invention having an impact absorbing layer that is comprised of a layer of air cellular material;

FIG. 5 is a side cross-sectional view of a composite mat having an impact absorbing layer that is comprised of a layer of air cellular material and a layer low-density foam;

FIG. 6 is a side cross-sectional view of a composite mat having an impact absorbing layer that is sandwiched between two non-foamed layers;

FIG. 7 is a perspective of the composite mat disposed on the floor of a horse trailer illustrating that the upper layer is detachable from the lower layer; and

FIG. 8 is a front view of a resiliometer.

### DETAILED DESCRIPTION OF THE INVENTION

The invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

It has been discovered that a composite fatigue mat having a dense polymer layer disposed on a foam layer having specific density and thickness parameters greatly increase's the mat's impact absorbance and thus reduces the amount of rebound force that is applied to a horse's legs and joints. The combination of the foam's specific density and thickness parameters and the orientation of the mat with the rubber layer on top and the foam on the bottom gives the mat its superior absorbance capabilities. To prevent excessive fatigue and stress on an animal, it is desirable that the mat should be able to absorb greater than 90% of an impact force applied to it. Mats absorbing from about 75% or 80 to 90% of the impact force applied are suitable, although 75% is about the minimum. Fatigue mats in accordance with the invention fall within the above desired impact absorbance ranges and thus help reduce stress and fatigue that may result in a horse during transportation.

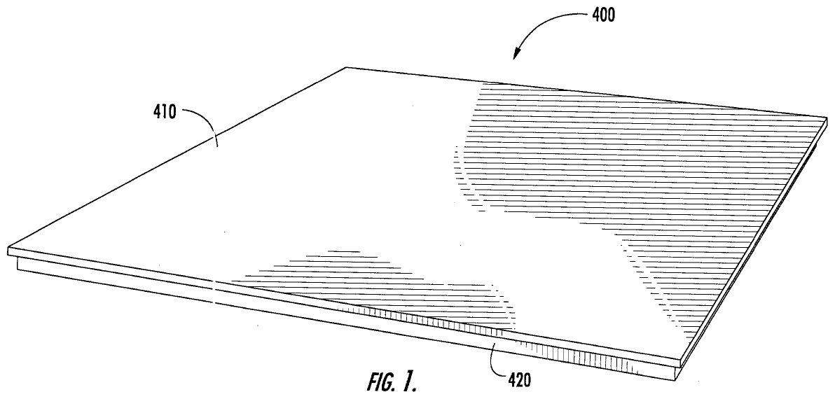

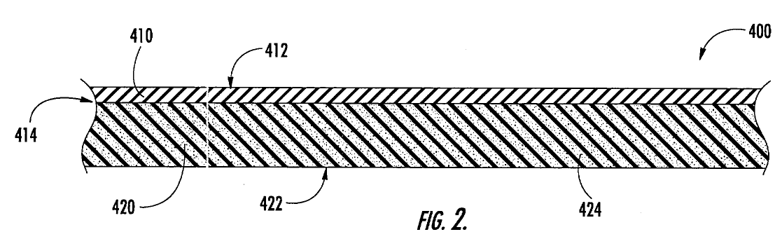

With reference to FIG. 1, reference number 400 broadly designates a fatigue mat embodying the features of the invention. The mat 400 is comprised of a dense rubber upper layer 410 and a low-density impact absorption layer 420. With reference to FIG. 2, the mat 400 is illustrated having an impact distributing layer 410. Disposed below the force distributing layer is the impact absorbing layer 420.

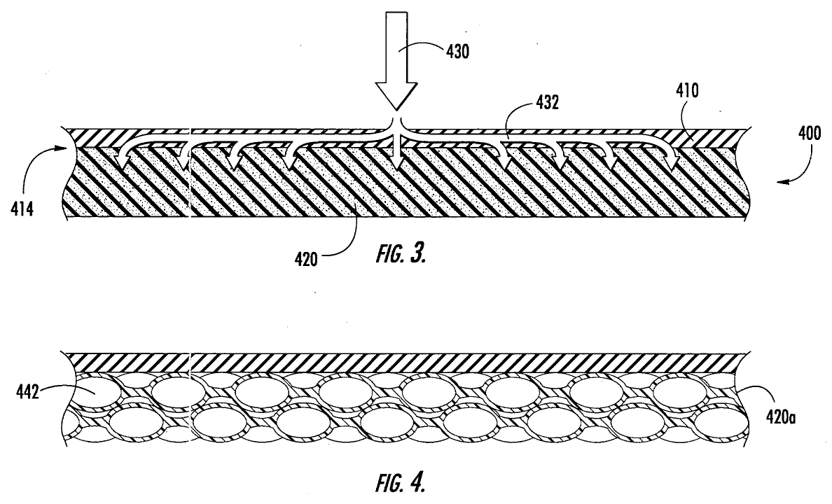

The force distributing layer is typically made from a dense rubber or synthetic polymer material. The term “rubber” as used herein should be understood to include any of a number of natural or synthetic polymers, including elastomers such as neoprene, spandex, copolymers of acrylonitrile and butadiene, butyl rubbers, ethylene-propylene rubbers, and foamed polymers having a density about 30 pcf or greater, and combinations thereof that have unique properties of deformation and elastic recovery. It is believed that this layer distributes the impact force throughout its surface before transferring the energy into the impact absorbing layer. In this regard, FIG. 3 illustrates a force 430 being applied downwardly into the mat 400 and being distributed throughout the distributing layer before being transmitted into the impact absorbing layer. The force distributing layer is at least about 1/8 inch thick. Thicknesses from ⅛ to 1.5 inches, and especially from about 1 to 5/8 inch are somewhat more typical. Mats having greater thicknesses can be used, although not necessarily with equivalent results.

The data in Table 1 is representative of the significant advantages that are obtained by placing the force distributing layer on top of the impact absorbing layer. The data was obtained by using ASTM Method 2632-92. Using a Resiliometer, FIG. 8, reference number 500, percent impact absorption was determined. The test consists of dropping a steel plunger 510 onto a sample material 512 and measuring the height of the plunger's rebound on the scale 514. The scale is graduated from 0 to 100 so that a rebound of 6.2% on the scale equals an impact absorbance of 93.8%, which means that only 6.2% of the impact force is retransmitted back into the horse's legs and joints.

TABLE 1

| | | Rebound | Impact Energy |
|---|---|---|---|
| Sample | Material | resiliency (%) | Absorption (%) |
| 1 | ½″ rubber mat | 39 | 61 |
| 2 | 1″ thick, 1.7 | 43 | 57 |
| | pcf LDPE foam | | |
| 3 | 1.7 pcf LDPE | 43 | 57 |
| | foam on top of | | |
| | ½″ rubber mat | | |
| 4 | ½″ rubber mat | 6.2 | 93.8 |
| | on top of 1.7 | | |
| | pcf LDPE foam | | |

As is evident from the data contained in Table 1, the orientation of the layers produces the desired impact absorbance. Sample 1, consisting of only the 12 inch rubber mat, absorbed only 61% of the impact energy, which is unacceptable to provide the desired range of protection. Likewise, samples 2 and 3, consisting of a foam layer and a combination of a foam layer disposed over a rubber mat, respectively, produced results that were outside the mat's acceptable impact absorbance range. It is when the rubber layer is placed on top of the foam layer that superior impact absorbance is achieved. It was not expected that sample 4 would produce better results than samples 1, 2, or 3, because sample 4 is comprised of the same materials that give unacceptable results in samples 1 and 2, and the difference between samples 3 and 4 is the manner in which the layers are oriented with respect to one another.

The impact absorbing layer 420 absorbs the impact force as it is transferred from the force distributing layer. A continuously extruded low-density polyolefin foam, such as polyethylene, is very useful as the impact absorbing layer. For example, Stratocell,® Celluplank,® and Cellu-cushion® polyethylene foams available from Sealed Air Corp. of Saddle Brook, N.J., are suitable. The impact absorbing layer may be a homogeneous or heterogeneous foam, or a laminate comprised of foam layers having different thicknesses and densities. Useful polyethylene resins include polyethylene homopolymers and copolymers. Useful polyethylene homopolymers include low-density polyethylene (LDPE), linear low-density polyethylene (LLDPE), and high-density polyethylene (HDPE). Polyethylene copolymers may include homogeneous ethylene/alpha-olefin copolymers, such as matallocene/single-site catalyzed copolymers of ethylene and one or more C₃ to C₁₀ alpha-olefin comonomers, or heterogeneous Ziegler-Natta catalyzed ethylene/alpha-olefin copolymers. Other ethylene copolymers include propylene, higher olefins and carboxylic acids and esters. Various ethylene copolymers are used in which the second comonomer is a carboxylic acid or ester such as vinyl acetate, acrylic acid, methacrylic acid, methacrylate and ethyl acrylate. Ethylene vinyl acetate (EVA) copolymers with vinyl acetate content ranging up to 30% weight could be used copolymers, such as homogeneous ethylene/alpha-olefin copolymers, heterogeneous Ziegler-Natta catalyzed ethylene/alpha-olefin copolymers, and ethylene vinyl acetate (EVA) copolymers, and combinations of the above-cited resins.

To obtain an acceptable impact absorbance, a low-density foam must have a density that is from about 1 to 2.2 pcf. A density below about 1 pcf will result in a foam that may be easily crushed resulting in loss of impact absorbance. A density greater than 2.2 pcf would result in an impact absorbance that is outside the acceptable range. A better impact absorbance is achieved by using a foam having a density that is below about 2.0, and the best impact absorbance is achieved with a foam having a density that is from about 1.2 to 0.7 pcf.

Table 2 illustrates the surprising results that foam density has on impact absorbance. Using ASTM Method 2632-92 the following results were obtained. A ½ inch rubber mat was used for the force distributing layer and 1 inch thick low-density polyethylene foams having various densities were uses as the impact absorbing layer.

TABLE 2

| | LDPE Foam | Rebound | Impact Energy |
|---|---|---|---|
| Sample | density (pcf) | resiliency (%) | Absorption (%) |
| 1 | 1.2 | 10 | 90 |
| 2 | 1.58 | 7.8 | 92.2 |
| 3 | 1.68 | 6.2 | 93.8 |
| 4 | 1.87 | 20 | 80 |
| 5 | 2.35 | 26.8 | 73.2 |
| 6 | 4.1 | 28.2 | 71.8 |

As is evident from Table 2, the foam's impact absorbance is reduced if the foam's density is greater than about 1.7 pcf. At greater than 2.2 pcf, impact absorbance is no longer acceptable. A comparison of samples 3 and 4 illustrates this result. Sample 3 has greater than 3 times the impact absorbance than sample 4, which is a surprising result because there is only a 5% difference between their densities. It was expected that impact absorption would not drastically change over a broad range of foam density and that 4 pcf foam woule be as effective as 2 pcf foam. As Table 2 shows, this is not the case and the best impact absorption is achieved with a foam having a density range from about 1.2 pcf to 1.7 pcf. Thus, Table 2 shows the surprising and beneficial results that are achieved by using foams that are within this specific density range.

Foam thickness is the second parameter affecting the fatigue mat's impact absorbance. For the most part, foam thickness is not as important as density to achieving the desired results. Acceptable impact absorbance is achieved with a foam that is at least about ½ inch thick or greater. Better results are achieved with a foam that is from about 1 inch thick or greater. Impact absorbance is not appreciably improved with foam that is greater than about 1 inch and weight and production and shipping costs may become an issue in foams exceeding about 4 inches.

Table 3 illustrates how foam thickness affects the mat's impact absorbance. The following data was obtained by using ASTM Method 2632-92. A 1/2 inch rubber mat was used for the force distributing layer and Stratocell® 1.7 pcf low-density polyethylene foams of various thicknesses were used as the test samples.

TABLE 3

| | LDPE foam | Rebound | Impact Energy |
|---|---|---|---|
| Sample | thickness (in.) | resiliency (%) | Absorption (%) |
| 1 | 0.576 | 13.8 | 86.2 |
| 2 | 1.005 | 6.2 | 93.8 |
| 3 | 1.508 | 9.6 | 90.4 |
| 4 | 2.135 | 8.2 | 91.8 |

Alternatively, a layer of air cellular cushioning material may be substituted as the impact absorbing layer. In this regard, FIG. 4 illustrates a mat 400 having an impact absorbing layer 420a that is comprised of an air cellular cushioning material. Typically, air cellular material is a flexible sheet containing numerous small air pockets that is made from a thin polymeric film, such as polyethylene. In order for the bubble layer to provide adequate impact absorption, the individual bubbles 442 must have a height that is from about ¼ to 1 inch, with bubbles that are about ½ inch providing the best results. Air cellular cushioning material under the trademark Bubble Wrap® or AirCap® available from Sealed Air Corp. of Saddle Brook, N.J., is suitable. Different air cellular material may be used, although not necessarily with equivalent results.

Table 4 illustrates the results that were obtained from using bubbles of different heights. The following data was obtained by using ASTM Method 2632-92. A ½ inch rubber mat was used for the force distributing layer. Small bubble height was about 1/8 inch and large bubble height was about ½ inch. Bubble height was measured using ASTM Method D3575. To determine bubble height a 4×4 inch sample of bubble material was placed on a flat base plate and a 4-inch diameter disc was placed over the sample. An 8 ounce weight was placed on top of the disc and then the thickness of the bubble material was measured with a gauge dial.

TABLE 4

| | Bubble | Rebound | Impact Energy |
|---|---|---|---|
| Sample | size | resiliency (%) | Absorption (%) |
| 1 | Small | 25.4 | 74.6 |
| 2 | Large | 9 | 91 |

Table 4 illustrates that small bubbles (bubble height is about 1/8 inch) do not provide the necessary level of impact absorption, and that large bubbles (bubble height is about 1/2 inch) have an impact absorbance that is within the most desirable range.

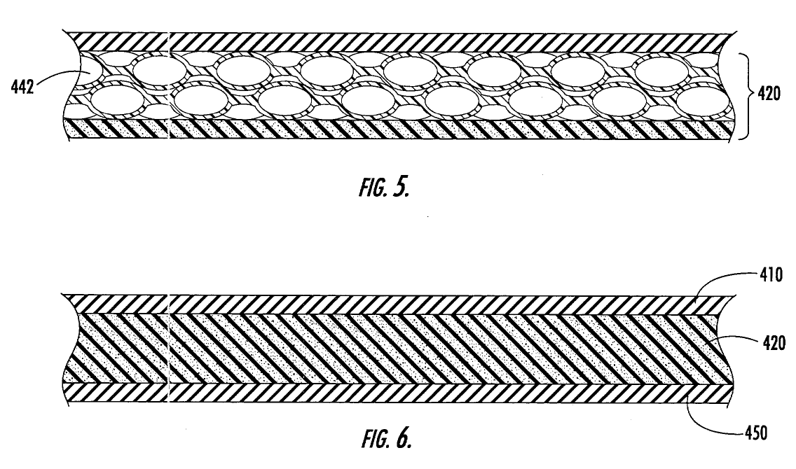

The impact absorbing layer can be formed from the combination of a layer of bubble material and a layer of foam. In this regard, FIG. 5 illustrates a fatigue mat having an upper force distributing layer and an impact absorbing layer that is comprised of the combination of a layer of bubble material and a layer of low-density foam. Preferred foam densities and thickness are the same as those discussed above.

Table 5 illustrates the results that were obtained from using a layer of bubbles in combination with a layer of low-density polyethylene foam. The following data was obtained by using ASTM Method 2632-92. A ½ inch rubber mat was used for the force distributing layer and 1 inch thick Stratocell® 1.7 pcf low-density polyethylene foam was used for the foam layer.

TABLE 5

| | Orientation | | |
|---|---|---|---|
| | of materials | Rebound | Impact Energy |
| Sample | (top to bottom) | resiliency (%) | Absorption (%) |
| 1 | ½″ mat Small | 9 | 91 |
| | bubble layer | | |
| | Foam layer | | |
| 2 | ½″ mat Foam | 8 | 92 |
| | layer Small | | |
| | bubble layer | | |
| 3 | ½″ mat Large | 8 | 92 |
| | bubble layer | | |
| | Foam layer | | |
| 4 | ½″ mat Foam | 5.2 | 94.8 |
| | layer Large | | |
| | bubble layer | | |

The data in Table 5 illustrates that an impact absorbing layer that is comprised of the combination of a bubble layer and a foam layer has preferred impact absorption. Although a layer comprised of small bubbles alone does not have acceptable impact absorption, Tables 5 and 6 shows that small bubbles may be used when they are combined with a layer of low-density polyethylene foam or when the small bubble layer is placed above a second non-foamed polymer layer.

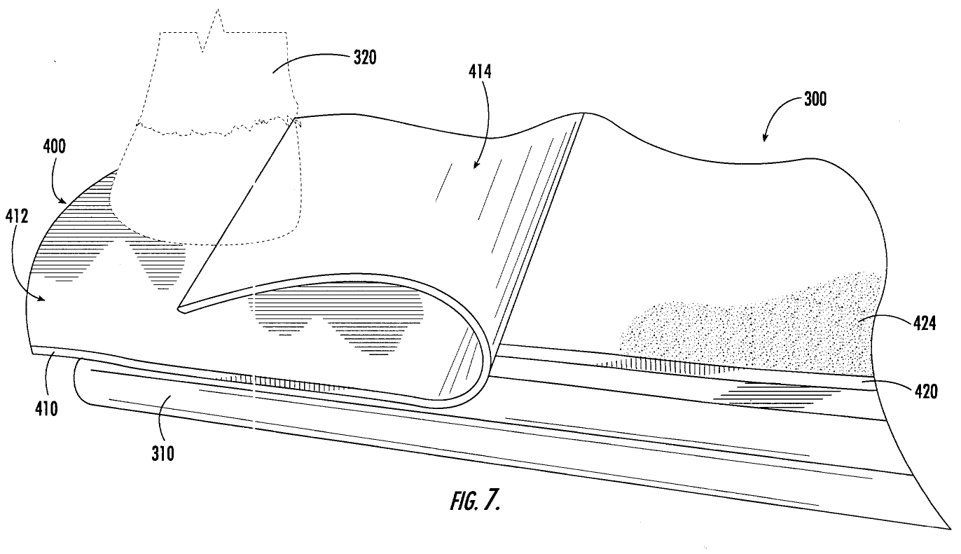

The fatigue mat can have a second rubber or dense polymeric mat located underneath the impact absorbing layer. In this regard, FIG. 6 illustrates a fatigue mat 400 having an upper force distributing layer 410 and an impact absorbing layer 420 sandwiched between a second mat 450 that may be comprised of the same or different material as the upper force distributing layer. The impact absorbing layer may or may not contain a layer of bubble material.

Table 6 illustrates the results that were obtained from using a fatigue mat having an additional rubber layer disposed below the impact absorbing layer. A ½ inch rubber mat was used for the force distributing layer and 1 inch thick Stratocell® 1.7 pcf low-density polyethylene foam was used for the foam layer. Small bubble height was about 1/8 inch and large bubble height was about 1/2 inch.

TABLE 6

| | Orientation | | |
|---|---|---|---|
| | of materials | Rebound | Impact Energy |
| Sample | (top to bottom) | resiliency (%) | Absorption (%) |
| 1 | ½″ mat | 16.6 | 83.4 |
| | Foam layer | | |
| | 0.2″ mat | | |
| 2 | ½″ mat | 9 | 91 |
| | Large bubble layer | | |
| | 0.2″ mat | | |
| 3 | ½″ mat | 24.8 | 75.2 |
| | Small bubble layer | | |
| | 0.2″ mat | | |

The force distributing layer and impact absorbing layer may also contain an antimicrobial and antifungal additives. Antimicrobial and antifungal additives neutralize the ability of bacteria and other microorganisms to grow, function, or reproduce. Normally, the antimicrobial agent is mixed with the polymer base resin during foam formation. Alternatively, the mat can be rendered antimicrobial by topically treating the force distributing layer with the antimicrobial agent.

The anitimicrobial agent is practically insoluble in water, and is safe, non-toxic, non-carcinogenic, and non-sensitizing to animals and humans. For example, antimicrobial agents such as 2,4,4′-trichloro-2′hydroxy diphenol ether, or 5-chloro-2-phenol (2,4 dichlorophenoxy) are commonly sold under the trademark Microban, by Microban Products Co. of Huntsville, N.C. Microban is incorporated into the structure of the polymer during formation and may last for the lifetime of the pad. Other useful antimicrobial agents include, without limitation, 10,10′-oxy-bis-phenoxarsin, N-(trihalogenomethylthio)-phthalimide, diphenylstibine-2-ethylhexanoate, copper-bis-(8-hydroxyquinoline), tributyltin oxide and its derivatives, and tri-n-butylin meleate. It is understood that the antimicrobial agent is not limited to those recited above, and other antimicrobial agents may be used. The rubber and impact absorption layers may also contain one or more additives including fillers, antioxidants, flame retardants, UV stabilizers, elastomeric components such as polyisobutylene, polybutadiene, and ethylene-propylene rubber, cross-linking agents, extrusion aids, colorants, pigments, antistatic agents, biostabilizers, and permeability modifiers such as esters and amides of fatty acids, pigments, dyes, plasticizers, or the like.

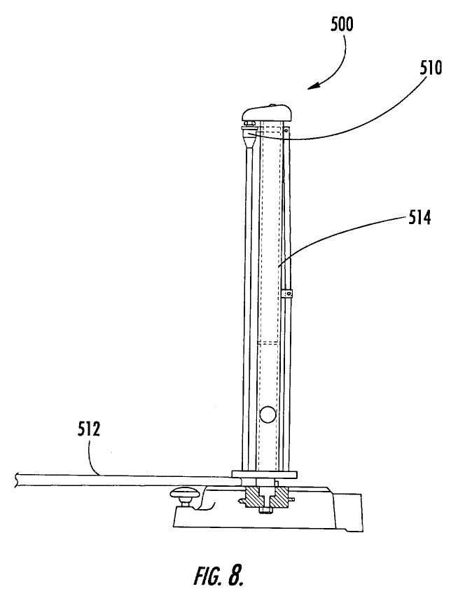

The force distributing layer may be attached to the impact absorbing layer with an adhesive, or more typically it is laid on top of the impact absorbing layer without the use of an adhesive. In this regard, FIG. 7 illustrates the distributing layer being pulled back on one side exposing the upper surface of the impact absorbing layer. As illustrated in FIG. 7, the mat 400 is shown disposed on a trailer's floor. The impact absorbing layer and the force distributing layer are sold to suppliers in bulk rolls or sheets where each layer is custom fitted to individual trailers. It is expected that the lifespan of the impact absorbing layer will be less than the force distributing layer and that selling the materials in separate rolls will allow the user to replace the individual layers after their respective usefulness has ended.

As is evident from the foregoing discussion, fatigue mats in accordance with the invention are ideally suited for use in a horse trailer. Their superior impact absorbance will help reduce fatigue and stress that may occur in a horse's legs and joints. Since the pads are constructed of rubber, foamed, and polymeric materials they resist moisture and are easily cleaned. The mats may also have many applications beyond horse trailers, such as use in an assembly line setting, where fatigue may occur in workers' legs after several hours of prolonged standing, and for specialty packaging and the like where impact forces are a concern.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A composite mat comprising:
a force distributing layer; and
and an impact absorbing layer disposed under said force distributing layer, said impact absorbing layer having a density that is from about 1 pcf to 2.2 pcf.

2. A composite mat according to claim 1, wherein said impact absorbing layer is a low-density foam.

3. A composite mat according to claim 2, wherein said foam is a continuously extruded foam.

4. A composite mat according to claim 2, wherein said foam is comprised of a resin selected from the group consisting of low-density polyethylene (LDPE); linear low-density polyethylene (LLDPE); high-density polyethylene (HDPE); ethylene vinyl acetate (EVA); metallocene/single-site catalyzed copolymers of ethylene and one or more C₃ to C₁₀ alpha-olefin comonomers; heterogeneous Ziegler-Natta catalyzed ethylene/alpha-olefin copolymers; ethylene copolymers of propylene, higher olefins, carboxylic acids, or esters, and combinations thereof.

5. A composite mat according to claim 2, wherein said impact absorbing layer has a density that is from about 1 to 2 pcf.

6. A composite mat according to claim 2, wherein said impact absorbing layer has a density that is from about 1.2 pcf to 1.7 pcf.

7. A composite mat according to claim 1, wherein said impact absorbing layer has a thickness that is about 4 inches or less.

8. A composite mat according to claim 1, wherein said impact absorbing layer has a thickness that is from about ½ to 2.5 inches.

9. A composite mat according to claim 1, wherein said impact absorbing layer has a thickness that is about 1 inch.

10. A composite mat according to claim 1, wherein said force distributing layer is rubber or synthetic rubber material.

11. A composite mat according to claim 1, wherein said force distributing layer has a thickness that is at least 1/8 inch thick.

12. A composite mat according to claim 1, wherein said force distributing layer is from about ¼ to 1.5 inches thick.

13. A composite mat according to claim 1, wherein said force distributing layer is from about ¼ to 5/8 inch thick.

14. A composite mat according to claim 1 further comprising an antimicrobial agent.

15. A composite mat according to claim 14, wherein said antimicrobial agent is selected from the group consisting of 4,4′-trichloro-2′hydroxy diphenol ether, 5-chloro-2-phenol (2,4 dichlorophenoxy), 10,10′-oxy-bis-phenoxarsin, N-(trihalogenomethylthio)-phthalimide, diphenylstibine-2-ethylhexanoate, copper-bis-(8-hydroxyquinoline), tributyltin oxide and its derivatives, and tri-n-butylin meleate.

16. A composite mat according to claim 1, wherein the force distributing layer and the impact absorbing layer further comprise an additive selected from the group consisting of aging modifiers, nucleating agents, elastomeric components, cross-linking agents, extrusion aids, antioxidants, colorants, pigments, permeability modifiers, antimicrobials, UV stabilizers, antistatic agents, biostabilizers, flame retardants, and combinations thereof.

17. A composite mat according to claim 2, wherein said impact absorbing layer further comprises a layer of air cellular material sandwiched between said force distributing layer and said low-density foam layer, said air cellular layer having bubbles that have a height that is at least a 1/8 inch.

18. A composite mat according to claim 1, wherein said bubbles are about 12 inch high.

19. A composite mat according to claim 1 further comprising:
a rubber layer disposed below said impact absorbing layer.

20. A composite mat comprising:
a force distributing layer having a thickness that is about 1/2 inch; and
and an impact absorbing layer disposed under said force distributing layer, said absorbing layer comprised of a low-density polyethylene foam having a density that is about 1.7 pcf and a thickness that is about 1 inch.

21. A composite mat comprising:
a force distributing layer; and
and an impact absorbing layer disposed under said force distributing layer, said impact absorbing layer comprised of air cellular material having bubbles that are from about 1/4 inch or greater in height.

22. A composite mat according to claim 21, wherein said bubbles have a height that is about 1/2 inch.

23. A composite mat according to claim 21, wherein said force distributing layer is rubber or synthetic rubber that is from about ⅛ to 1.5 inches thick.

24. A composite mat according to claim 21, further comprising a rubber layer disposed below said impact absorbing layer.

25. A horse trailer comprising:
a trailer having a floor; and
a fatigue mat disposed on said floor, said mat having a force distributing layer and an impact absorbing layer disposed under said force distributing layer, said impact absorbing layer having a density that is from about 1 pcf to 2.2 pcf.
